(19) United States
(12) Patent Application Publication
(10) Pub. No.: US 2012/0175059 A1
(43) Pub. Date: Jul. 12, 2012

(54) Ballistic-resistant fabrications

(76) Inventor: Christopher Gillis, Shavertown, PA (US)

(21) Appl. No.: 11/880,615

(22) Filed: Jul. 23, 2007

Related U.S. Application Data
(62) Division of application No. 11/150,057, filed on Jun. 10, 2005, now abandoned.

(51) Int. Cl. B32B 37/14; B23P 11/00; B32B 37/12

(52) U.S. Cl. 156/330; 156/60; 29/428

(57) ABSTRACT

A ballistic-resistant fabrication including a matrix formed by a number of elongated used tire segment layers along with high strength sheeting material which may be held together with an interstitial material, such as epoxy. More layers may be utilized as needed. These layers may be non-bonded, partially, or completely bonded and/or covered with other materials to produce a finished product. Due to the deformable and frictional properties of the rubber, along with the tensile strength of the sheeting, the fabrication has the ability to absorb and protects against multiple projectile impacts. These ballistic-resistant fabrications are much less expensive to produce than similar conventional products due to the use of recycled rubber tires and/or recycled plastic material, but are very efficient in resisting penetration by ballistic projectiles.

### BACKGROUND OF THE INVENTION

1. Field of the Invention

This invention relates generally to construction fabrications and more specifically to a fabrication constructed chiefly of recycled tires and other materials designed to provide protection from ballistic projectiles and other hazards.

2. Discussion of Related Art

Construction elements are typically designed to support some type of building or structure. They are not designed strong enough to resist excessive forces and/or stresses due to the additional cost associated with such designs.

There are times in which additional protection is required. For example, in hurricane prone areas it would be advantageous to have a structure which can withstand high-speed winds and the impact of projectiles thrown by the high speed winds.

In violence prone areas, anti-ballistic panels or fabrications capable of protecting against projectiles fired from small-to-heavy arms would be useful. In addition, fabrications which would protect residents from explosions has obvious safety advantages over many currently used construction materials.

There currently are anti-ballistic fabrications available, however, these have their shortcomings. Many of these types of fabrications are very expensive so as to prohibit use in construction.

Others are designed for a single use and shatter upon receiving an impact. After taking a single ‘hit’, they are not capable of providing any additional protection. In many uses, there will be multiple ballistic objects impacting the fabrications. Therefore, these would not be suitable for use as construction materials.

Currently there is a need for anti-ballistic fabrications which may be used in construction which have the capability to deflect numerous ballistic objects and are economical to produce.

### SUMMARY OF THE INVENTION

The present invention may be embodied as a ballistic-resistant fabrication having a plurality of layers comprising:
a. at least one layer of a recycled deformable material;
b. at least one sheet of high tensile strength material attached to the deformable material designed to catch a projectile and deform to dissipate its kinetic energy.

The fabrication may also include interstitial materials such as plastics, epoxies, glues which are preferably recycled materials. It may also include metal or other ballistic-resistant sheets for additional impact protection. Since most of the materials are considered waste materials or recycled, these can be made cheaply. Also, since the materials use deformable materials and a different mechanism for dissipating kinetic energy, they are able to protect against repeated impacts, unlike many prior art ballistic-resistant fabrications.

The present invention includes a method of producing ballistic-resistant fabrications comprising:
providing strips of recycled deformable materials;
arranging the strips of deformable materials to closely abut each other into layers of deformable materials;
adding at least one layer of a ballistic-resistant sheeting to the fabrication;
holding the layers together to result in a unitary fabrication.

It is also envisioned that these fabrications may include metal reinforcements, interstitial materials as described above, and additional layers of deformable materials and ballistic-resistant sheeting. This results in a very efficient, protective fabrication which may be produced at a low cost thereby make them feasible for use as construction materials. Now it is possible to build residences which are secure and protected from both human threats as well as the threats of nature.

### OBJECTS OF THE INVENTION

Accordingly, a primary object of the present invention is to provide a novel ballistic-resistant fabrication which is manufactured from used tires in combination with other ballistic-resistant materials.

Another object of the invention is to provide the above novel ballistic-resistant panel which includes a matrix formed by portions of material obtained from discarded vehicle tires in conjunction with other ballistic-resistant materials. The construction materials are combined in layers to form a fabrication. The layers may be combined in a loose fashion or may be bonded together either partially or completely so that a finished composite product is produced which will be resistant to penetration by moving objects.

Other objects and advantages will become apparent from reading the following detailed description of the invention wherein reference is made to the accompanying drawings.

### BRIEF DESCRIPTION OF THE DRAWINGS

A complete understanding of the present invention may be obtained by reference to the accompanying drawings, when considered in conjunction with the subsequent detailed description, in which:

FIG. 1 is an illustration of a projectile moving toward a prior art anti-ballistic fabrication.

FIG. 2 is an illustration of the projectile at the moment of impact with the anti-ballistic fabrication of FIG. 1.

FIG. 3 is a plan view of a partially completed ballistic-resistant fabrication consistent with an embodiment of the present invention.

FIG. 4 is an enlarged cross-sectional side view illustration of a ballistic-resistant fabrication according to one embodiment of the present invention, also showing a projectile moving toward the fabrication.

FIG. 5 is a cross-sectional side view illustration of the ballistic-resistant fabrication of FIG. 4 showing the projectile slightly after impact with the fabrication.

FIG. 6 is an enlarged partial view of FIG. 5 showing forces on the projectile induced by the fabrication.

FIGS. 7a and 7b are illustrations of a projectile being diverted by differential forces on different sides of the projectile.

### DETAILED DESCRIPTION OF THE INVENTION

### General

The novel unit of the invention is advantageous in that it is manufactured partly from inexpensive, recycled, raw materials such as used tires and/or recycled plastic.

The end unit is strong, resistant to projectiles and the elements, and produces the desired resistance at a relatively inexpensive cost.

The engineered properties of a conventional tire, i.e. strength, durability, and resistance to penetration and the environment, are preserved and reused in the form of a ballistic-resistant fabrication. Also, the use of recycled plastic or other bonding agents in the encapsulation process improves the desirable characteristics of strength, rigidity, and resistance to the environment and may help reduce the cost of manufacture since it is commonly considered a waste or low-value material.

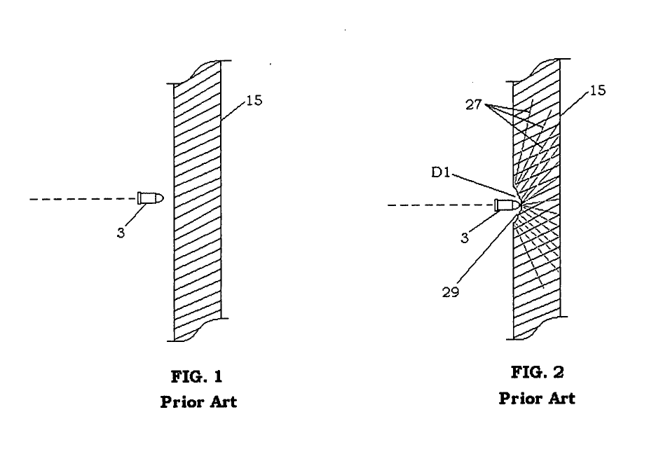

FIG. 1 is an illustration of a projectile 3 moving toward a prior art anti-ballistic fabrication 15. This type of fabrication is a single use-type fabrication designed to withstand an impact with a projectile. These are typically of a crystalline structure such as glass or ceramic.

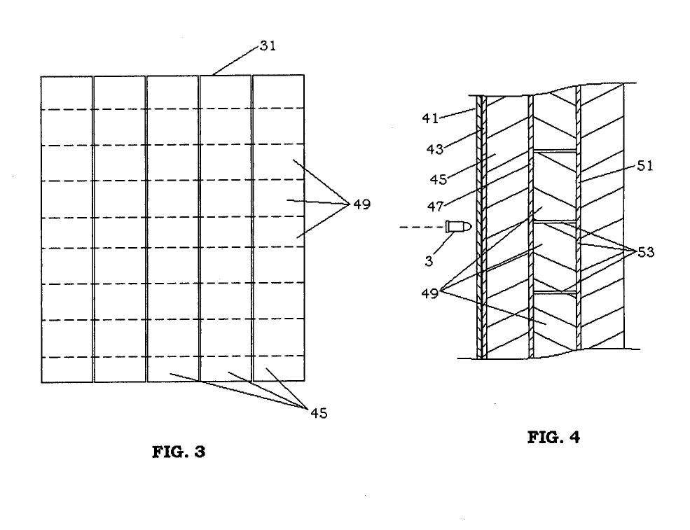

FIG. 2 is an illustration of projectile 3 of FIG. 1 at the moment of impact with the anti-ballistic fabrication 15 of FIG. 3. There is a slight indentation 29 made at the point of impact having a depth from the original surface of D1. Since this is not designed to flex, the entire kinetic force of the projectile is dissipated in a small period of time, being the period of impact and deformation. The projectile decelerates over the distance of indentation 29, D1, in the time it takes to traverse indentation 29.

The energy is radiated throughout the crystalline structure through fracture lines 27. Since creating the fracture requires energy and since there are so many fracture lines, fabrication 15 has the ability to absorb the impact of a ballistic projectile.

Once fabrication 15 has absorbed the impact, it has numerous fracture lines 27, and is significantly weakened so that it cannot absorb another ballistic impact, and typically does not have the structural integrity to act as a support for a building as a construction fabrication would.

FIG. 3 is a plan view of a partially completed ballistic-resistant fabrication 31 consistent with an embodiment of the present invention. This shows the construction of fabrication 31 with a plurality of deformable strips 45, preferably from the belt sections of recycled tires, shown after being flattened and aligned side-by side abutting each other. The deformable strips 45 would constitute a single layer of panel 31.

Additional layers are then added which may include ballistic-resistant sheeting (43, 47 of FIG. 4) such as Kevlar® and/or equivalent materials. Metal sheets may also be employed. To create the proper strength, multiple layers of deformable strips are used but the strips are not aligned with the other layers. This arrangement offsets the locations of where the strips abut, thereby eliminating weak spots. Additional layers of deformable strips (49 of FIG. 4) are shown in phantom in FIG. 3.

The layers are best described in connection with a completed cross section of fabrication 31 shown in FIG. 4. FIG. 4 is an enlarged illustration of ballistic-resistant fabrication 31 of FIG. 3 from an elevational sectional side view, also showing a projectile moving toward panel 31.

The outer surface may have a covering 41 which provides an appealing finish. This is optional, however some embodiments of the present invention are intended to be used in place of conventional construction materials and must be aesthetically pleasing.

A layer of sheeting 43 designed to have high tensile strength is employed. This may be formed or woven of a material such as Kevlar® designed to have ballistic-resistant properties.

Next is a layer of recycled tire strips 45 arranged in a tight side-by-side fashion and oriented in a longitudinal direction.

The next internal layer would be another layer of sheeting 47 similar to sheeting 43.

A layer of recycled tire strips 49 is aligned in a tight pattern 90 degrees different from that of tire strips 45. This insures that the locations where tire strips 45 abut each other do not line up with the locations where tire strips 49 abut each other.

Another layer of sheeting 51 is employed over tire strips 49.

An interstitial material 53 may be used to hold the layers together and to fill interstitial spaces, such as an epoxy. Other glues, fillers or recycled materials, such as plastics may be used as interstitial materials.

In optional embodiments, one or more sheets of metal may be employed between any of the layers described above for additional strength.

Fabrications 31 may be constructed of any number of layers using different locations and combinations of individual layers and are within the scope of the present invention.

Also, it is envisioned that the fabrications will be formed in various shapes to fit the specific needs. They may be curved, have irregular shaped edges and be molded and formed to fit and/or retrofit existing structures.

### Covering

The ballistic-resistant unit of the invention may be further enhanced with additional coverings of solid or liquid materials intended to encapsulate, protect, provide a specific finished surface, physical or chemical characteristic or add aesthetic qualities to the finished product.

### Additional Materials

The ballistic-resistant unit of the invention may be further enhanced with additional layers of ballistic-resistant materials which are typically used in such products. These layers may include, but not be limited to, metal, ballistic resistant fabrics, ceramics, gels and other ballistic-resistant materials in various shapes, sizes or forms alone or in various combinations along with portions of used tires to produce the desired results.

### Bonding Agents

The ballistic-resistant unit of the invention may be assembled in a loose fashion, be partially bonded, or fully bonded with various bonding agents that are typically used to bond materials together. The bonding agents used may include, but not be limited to, virgin polymers, recycled polymers, paints, epoxies, glues or any bonding agent. The bonding may also be provided through the utilization of physical bonding devices such as nails, pins, staples, stitching, or other attachment means which may physically bond the subject layers together.

The construction of deformable tire strips in conjunction with high tensile strength sheeting provides surprising ballistic-resistant effects which will be shown and described in connection with the following figures.

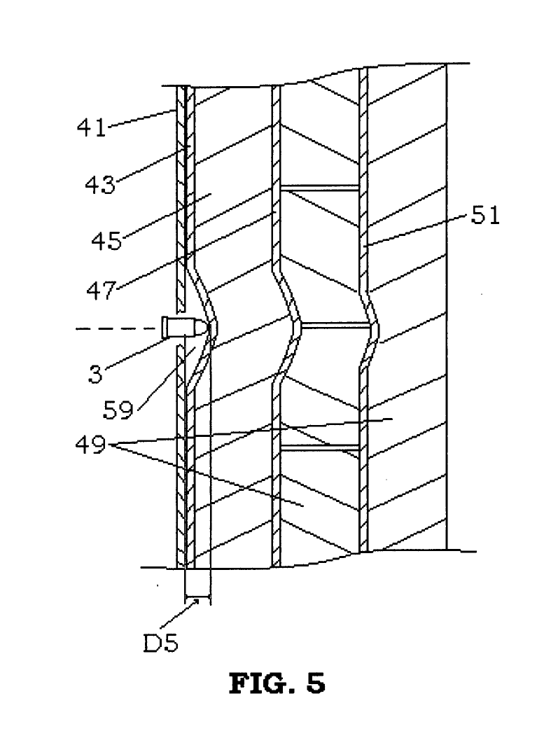

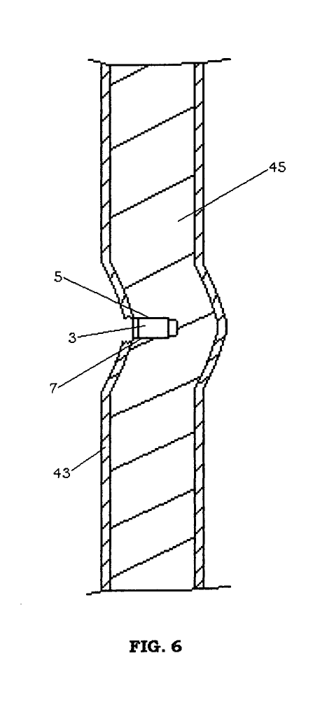

FIG. 5 is a cross-sectional side view illustration of the ballistic-resistant fabrication 31 of FIGS. 3 and 4 showing a projectile 3 slightly after impact with the fabrication. In this embodiment, covering 41 is penetrated by projectile 3.

Projectile 3 impacts with sheeting 43 causing sheeting 43 and the underlying tire strips 45, 49 and intermittent sheeting 47 to indent a depth of D5 creating indentation 59. Since sheeting layers 43, 47 have high tensile strength, and are backed by deformable tire strip layers, they are allowed to dissipate the projectile 3′s energy over a distance D5. The strands of the sheeting 43, 47 stretch and absorb the kinetic energy much like a person catching a baseball in a net.

If projectile 3 breaks through the first layer of sheeting 43, it then passes through tire strips 45 as shown in FIG. 6.

FIG. 6 is an enlarged partial view showing forces on projectile 3 induced by the deformable layers such as layer 45. As projectile 3 passes through deformable layer 45, sides of projectile 5 and 7 receive frictional forces exerted by the rubber. This does not occur in the prior art crystalline structures. These forces dampen the speed of projectile 3 causing it to turn kinetic energy into frictional heat energy. The rotational inertia stabilizes the projectile, causing it to follow a straight-line course. This is especially true of rifled projectiles. As the rotational inertia diminishes, the forces keeping it moving along the straight-line course diminish and the projectile is more apt to deviate from its course and tumble.

### Tumbling

The forces on the sides of projectile 3 as it passes through deformable layer 45, cause a dampening of rotation of projectile 3. Projectiles which do not spin axially (rifle) lack significant rotational inertia, deviate and veer from their straight-line course.

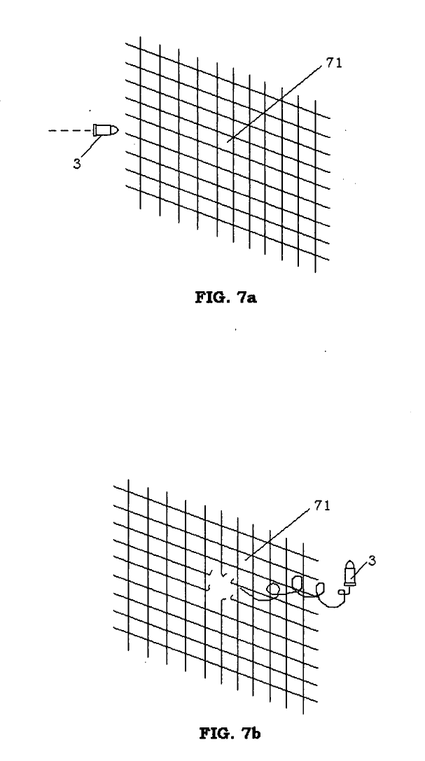

In addition, since deformable layers 45, 49 are constructed from the belt portion of tires which typically contain steel belt mesh 71, as shown in FIG. 7a. Projectile 3 may impact several strands of belt mesh 71. Since it is unlikely that projectile 3 would impact the same number of strands evenly across the projectile, the differential forces on projectile 3 would cause the projectile 3 to tumble as shown in FIG. 7b. A tumbling projectile now has a larger cross section impacting materials (hitting sideways) and therefore dissipates its energy over a larger area, limiting the projectile 3′s penetration abilities.

Therefore the dampening of rotational energy, and the differential forces on different sides of the projectile exhibited by the steel belts, increase the degree of tumbling of projectile 3 and minimize its penetration abilities.

### Interface Impacts

Panel 31 exhibits surprising ballistic-resistant properties which are theorized to be attributed to the mechanisms described above. In addition, it is also theorized that the properties may be due to shock waves produced when projectile 3 hits the interface between materials of differing hardness and deformability. The numerous impacts at interfaces between various materials as it passes through fabrication 31 may be the cause of this significant energy dissipation and provides unusual ballistic-resistant properties.

### Economics

There is currently a large supply of used tires and recycled polymers. These supplies are expected to remain high into the foreseeable future. Often, those who accept discarded used tires are paid to do so and recycled polymers may be obtained for a fraction of the cost of virgin materials. Considering that the economics associated with using these materials in effect amounts to a large subsidy defraying the costs associated with normal raw materials, the novel ballistic-resistant unit of the invention is produced more inexpensively and may be sold at lower prices than prior conventional ballistic-resistant fabrications.

### Environmental Impact

The use of discarded tires and/or recycled plastic not only contributes to the low cost of the ballistic-resistant unit of the invention, but it also benefits the environment by reducing the amount of waste contaminating the environment.

### Economics

Since these are constructed of waste materials, used tires and recycled plastics, they may be made very cheaply. They may also be mass produced to make good use of such refuse and simultaneously diminish waste piles of used tires, which have become a great concern.

The present invention also provides a limitless supply of raw materials for protection in a time when terrorist attacks may become common. Therefore, the present invention helps the local environment, while making it affordable to build secure buildings resistant to attacks as well as violent natural storms.

What is claimed is:

1. A method of producing ballistic-resistant fabrications comprising:
a. providing strips of recycled deformable materials;
b. arranging the strips of deformable materials to closely abut each other into layers of deformable materials;
c. adding at least one layer of a ballistic-resistant sheeting to the fabrication;
d. holding the layers together to result in a unitary fabrication.

2. The method of claim 1 wherein the recycled deformable material is taken from used tires.

3. The method of claim 1 further comprising:
adding metal reinforcement as an additional layer.

4. The method of claim 3 further comprising:
the metal reinforcement is metal sheeting.

5. The method of claim 1 further comprising:
adding an interstitial material to facilitate bonding of the layers.

6. The method of claim 5 wherein the interstitial material is selected from the group consisting of: a bonding agent, an epoxy, a virgin polymer, a recycled polymer, a glue, and a paint

7. The method of claim 1 further comprising:
pressing the layers together to facilitate in holding the layers together as a unitary fabrication.
